(19) United States
(12) Patent Application Publication
(10) Pub. No.: US 2003/0020221 A1
(43) Pub. Date: Jan. 30, 2003

(54) Load centering spring perch

(76) Inventor: Richard Pare, Speedway, IN (US)

Correspondence Address: David E. Novak, Woodard, Emhardt, Naughton, Moriarty and McNett, Bank One Center/Tower, 111 Monument Circle, Suite 3700, Indianapolis, IN, 46204-5137, US

(21) Appl. No.: 10/205,163

(22) Filed: Jul. 25, 2002

Related U.S. Application Data
(60) Provisional application No. 60/307,767, filed on Jul. 25, 2001.

(51) Int. Cl. F16F 1/06

(52) U.S. Cl. 267/179

(57) ABSTRACT

A spring perch assembly for automatically centering a load applied to a spring is provided. The assembly includes a body portion and a base portion which form a hollow cavity when engaged and may tilt relative to one another. When disposed between a spring and an applied load, the assembly automatically centers the load along the spring's centerline.

This application claims priority to and incorporates by reference U.S. Provisional Application Serial No. 60/307,767 filed Jul. 25, 2001.

### FIELD OF THE INVENTION

The present invention relates generally to an improved device and method for centering a load on a spring.

### BACKGROUND OF THE INVENTION

Three basic types of coil compression springs are known in the industry. An open end spring consists of a wire coil which follows a single helix angle to the end of the wire. An unground, closed end spring has an end which touches the last coil of the spring. In a ground, closed end spring, the tip of the final coil is shaped such that when the tip touches the last coil of the spring, a flat upper surface is produced. Most standard automotive springs are open end springs as they are relatively inexpensive to produce. In contrast, most high-performance springs used in racecars are ground, closed end springs.

As a load is applied to compress a coil spring, the force is not distributed evenly across the face of the spring. Where this load concentration occurs on the spring varies with the type of spring used. For example, in an open end spring the load is concentrated between the end of the spring and the point at which the load ceases contact with the spring. As the load is increased, this point moves away from the end tip of the spring. In closed end springs, the load is concentrated primarily at the end tip. The consequences of this uneven loading are illustrated in lateral or offset loads such as in vehicle suspension systems. In general, a vehicle suspension system is provided with a helical compression spring designed to provide a coil axis that coincides with the direction of reaction force of the spring. In a strut-type suspension system, a shock absorber is employed as a strut for positioning the vehicle's wheels. If there is a displacement between the load axis and the strut axis, a bending moment is exerted on the strut. This lateral force may prevent the piston from sliding smoothly in the guide to act as a shock absorber.

This problem is illustrated in FIGS. 1-2. A traditional closed-end coil spring 200 having a load-bearing platform 210 at one end is shown in an unloaded state in FIG. 1 disposed against a base 212. In the unloaded state, the first side of the spring 202 is substantially equal in height to the second side of the spring 204. In this example, the point of first contact 206 between the spring 200 and the platform 210 is on the second side of the spring 204.

When a load 220 is applied to the spring 200, the spring is compressed as shown in FIG. 2. As the load is applied, the spring initially compresses to a greater degree at the first point of contact 206 than compared to the first side of the spring 202. As a result, the second side of the spring 204 is compressed to a greater degree than the first side of the spring 202. This offset loading of the spring results in a bending moment applied to the spring. This bending moment is usually undesirable and may result in unanticipated or degraded performance or premature wear of the final spring assembly. Typically this problem has been addressed by using larger and heavier springs in the context of vehicle suspension systems.

Accordingly, there is a need for a device which assists in centering the load applied to a coil spring, allowing the load to be concentrated at the centerline of the spring. In the context of vehicle suspension systems, preferably such a device is lighter and more efficient than current devices. Prior attempts to solve these problems have been unsuccessful. The present invention addresses these concerns.

### SUMMARY OF THE INVENTION

The invention is set forth in the claims below, and the following is not in any way to limit, define or otherwise establish the scope of legal protection. In general terms, the present invention relates to an assembly for automatically centering the load applied to a spring.

One object of the present invention is to provide an assembly having two pivotably coupled members and a cavity disposed therebetween. When disposed between a spring and an applied load, the members of the assembly pivot relative to one another to center the load on the spring.

Another object of the present invention is to provide a method for automatically centering a load applied to a spring using a load-centering assembly disposed between the spring and the load.

Yet another object of one embodiment of the present invention is to provide an assembly for centering the load applied to a spring which utilizes hydraulic pressure to automatically center the load.

Further objects, embodiments, forms, benefits, aspects, features and advantages of the present invention may be obtained from the present disclosure.

### BRIEF DESCRIPTION OF THE DRAWINGS

FIG. 1 is a side view of a coil spring according to the prior art in an unloaded state.

FIG. 2 is a side view of a coil spring according to the prior art in a loaded state.

FIG. 3 is a partial cross-sectional view of a spring perch assembly according to one embodiment of the present invention.

FIG. 4 is a partial cross-sectional view of a spring perch assembly according to another embodiment of the present invention.

FIG. 4A is a partial cross-sectional view of another embodiment of a spring perch assembly according to the present invention

FIG. 5 is a partial cross-sectional view of a spring perch assembly according to another embodiment of the present invention.

FIG. 6 is a partial cross-sectional view of a spring perch assembly according to yet another embodiment of the present invention.

FIG. 7 is a perspective view of a spring according to one embodiment of the present invention.

FIG. 8 is a perspective view of a spring according to another embodiment of the present invention.

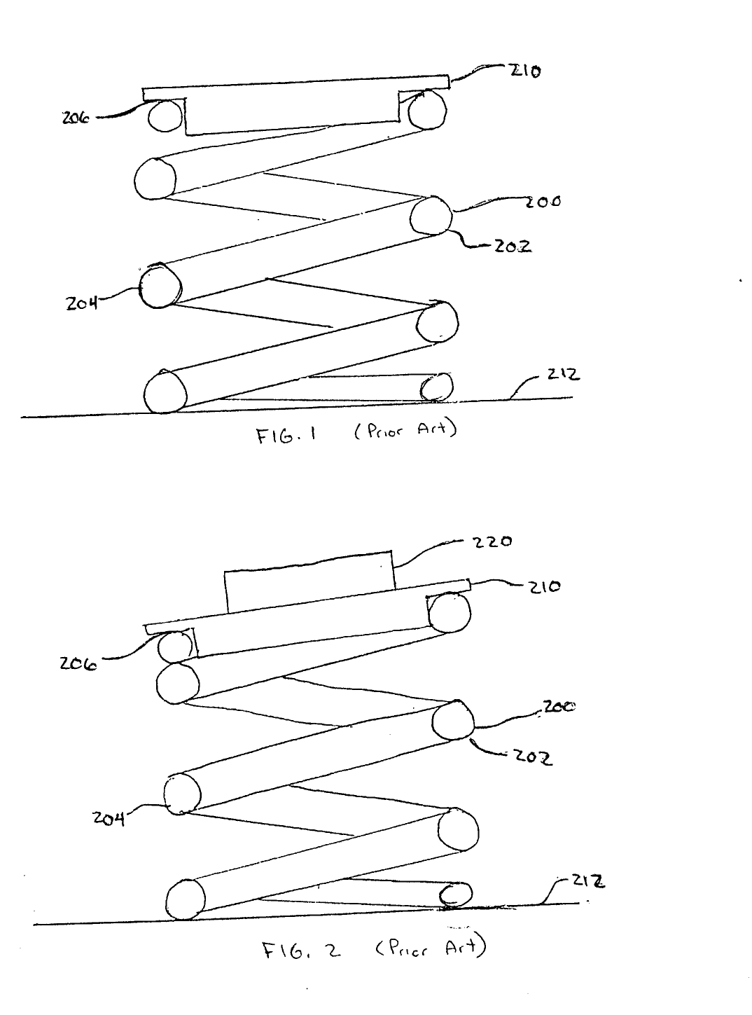

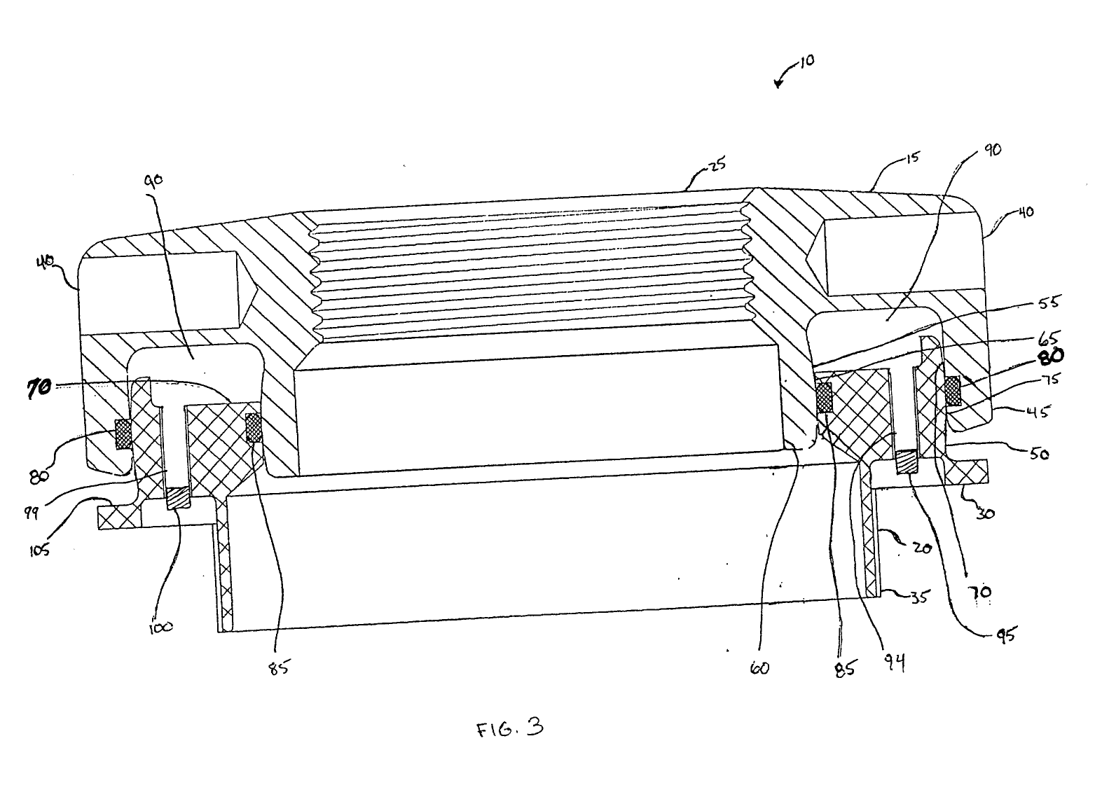

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, and alterations and modifications in the illustrated device and method and further applications of the principles of the invention as illustrated therein, are herein contemplated as would normally occur to one skilled in the art to which the invention relates.

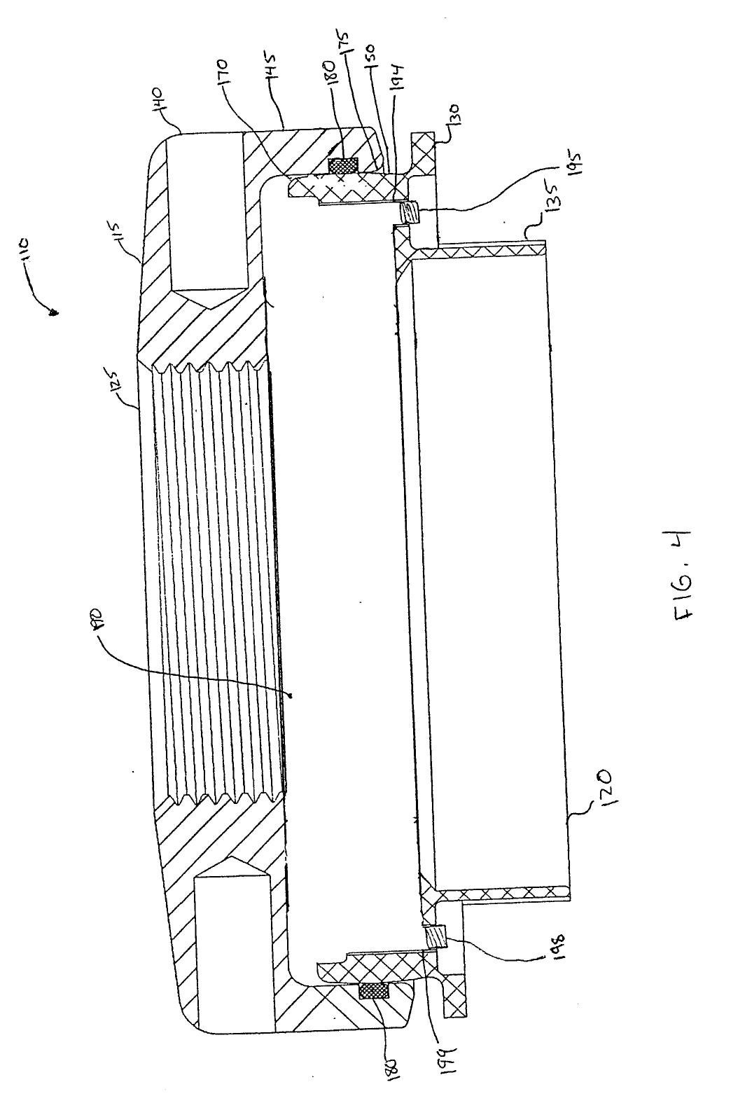

FIG. 3 shows a partial cross-sectional view of a spring perch assembly 10 according to one preferred embodiment of the present invention. The perch assembly comprises a body portion 15 and a base portion 20. The body portion 15 includes an outer flange 45 having a straight inner wall 75 and an inner flange 60 having a curved outer wall 55. Optionally the body portion may also include one or more wrench sockets 40 and a central, threaded socket 25 for attachment to a load. For example, in a vehicle suspension system a shock absorber may be attached to the socket. The base 20 portion of the perch assembly includes an annular wall 70, a lateral flange 30 and a spring locating guide 35. The annular wall portion 70 of the base has a curved outer wall 50 and a straight inner wall 65. A less preferred alternative includes straight outer and inner walls for the body portion and base portions.

The body portion of the assembly is sized to receive the base portion such that outer surface 55 of the inner flange 70 of the body member has a slightly smaller diameter than the inner surface 65 of the annular wall 70 of the base member and such that the outer surface 50 of the annular wall 70 of the base member has a slightly smaller diameter than the inner wall 75 of the outer flange 45 of the body member. This allows the body member to freely pivot relative to the base member without disengaging the base member. In one embodiment of the present invention, the body member may pivot up to approximately 4° relative to the base member. The present invention also contemplates assemblies which allow a greater or lesser range of pivot between the body member and the base member.

Preferably, the inner and outer wall of the body member and the inner and outer wall of the base member are machined to a smooth finish to reduce friction. Optionally, these surfaces may be coated with a low-friction material to further reduce friction. This material may be applied in any suitable manner such as spraying, spray and bake, or as a dry film. Examples of suitable materials include Krytox® and Teflon® manufactured by DuPont, although other suitable materials may also be used.

When the base member 20 is engaged with the body member 15, the inner surface 65 of the annular base wall 70 engages the outer surface 55 of the inner body flange 60 and the inner surface 75 of the outer body flange 45 engages the outer surface 50 of the annular base wall 70. This forms a circular cavity 90 between the body portion and the base portion of the assembly. To ensure the cavity is tightly sealed, suitable seals, such as O-rings 80 and 85, may be disposed between the inner surface of the annular base wall and the outer surface of the inner body flange and between the inner surface of the outer body flange and the outer surface of the annular base wall. Optionally, these O-rings 80 and 85 may be impregnated or coated with a low-friction material such as Krytox®. As the outer wall 55 of the inner flange 60 of the body member and the outer wall 50 of the annular wall 70 of the base member are curved, they exert an even pressure across the face of the O-rings 80 and 85 as the body member is pivoted relative to the base member.

The cavity 90 may be filled with a volume of oil, hydraulic fluid or other suitable fluid through a fluid passage 94 in the base portion which is sealed using a screw 95. Air may be removed from the cavity during the filling process through an air bleed passage 99 which is sealed with a screw 100. Preferably, the cavity 90 is filled with a suitable fluid until the body member floats on the fluid without disengaging from the base member.

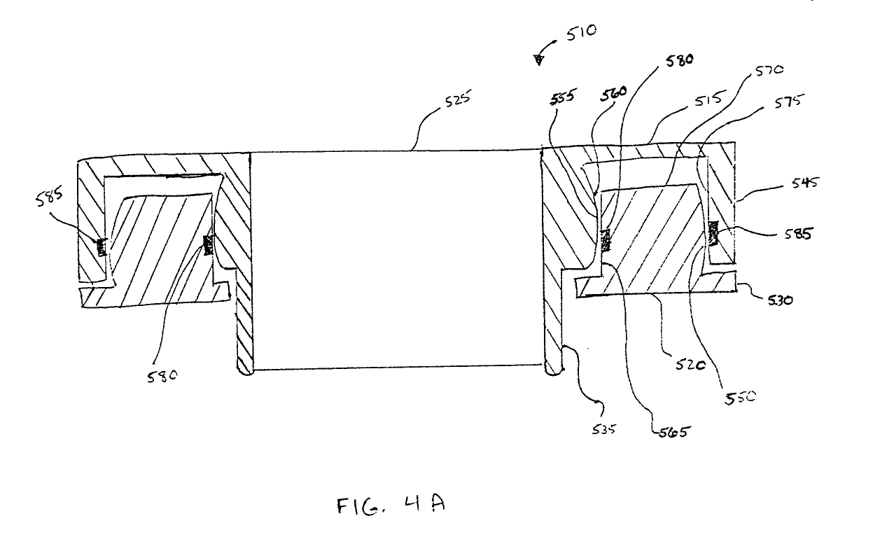

FIG. 4 shows an alternate preferred embodiment of the present invention. In this embodiment, the body portion 115 of the assembly 110 includes an outer flange 145 having a straight inner wall 175. The base portion 120 of the assembly includes an annular wall 170 having a curved outer surface 150, a lateral flange 130 and a spring locating guide 135. The base and body portions of the assembly are sized such that the outer surface 150 of the annular wall 170 has a slightly smaller diameter than the inner surface 175 of the outer flange 145 of the body member. This allows body member 115 to freely pivot relative to the base member 120 without disengaging the base member.

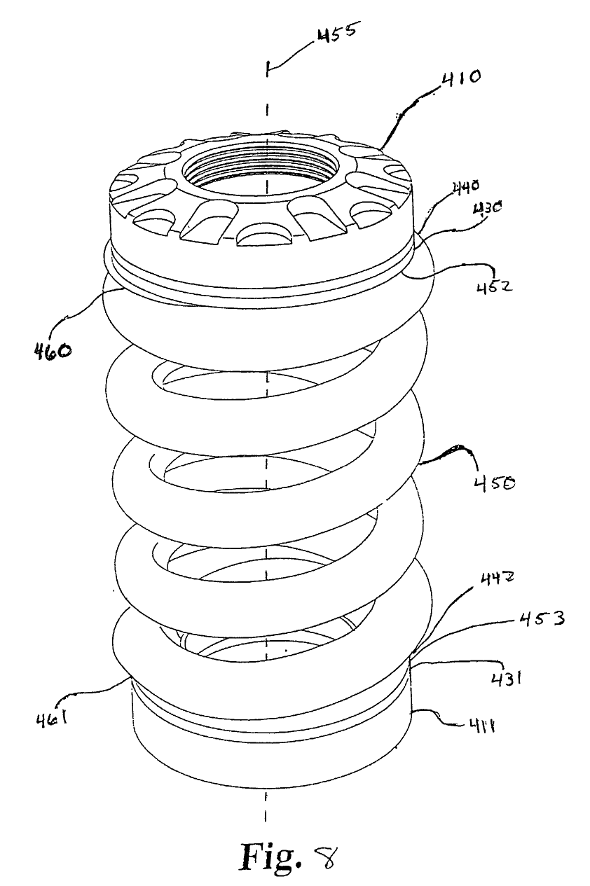

When the base member is engaged with the body member, the inner surface of the body flange 175 engages the outer surface of the annular base wall 150. This forms a cavity 190 between the body member and the base member. An O-ring 180 such as described in FIG. 3 may be positioned between the inner surface 175 of the body flange and the outer surface 150 of the annular base wall to ensure the cavity 190 is tightly sealed. Optionally, the inner surface 175 of the body flange, the outer surface 150 of the annular base wall and the O-ring 180 may be coated with a low-friction material. This cavity 190 may be filled with a hydraulic fluid such as oil through a fluid passage 94 in the base portion which is sealed using a screw 195. Air may be removed from the cavity during the filling process through an air bleed passage 199 which is sealed with a screw 198. Operation of the embodiments described by FIGS. 3-4 will be described in greater detail with reference to FIGS. 7-8.

An alternate preferred embodiment of the present invention is shown in FIG. 4A. The perch assembly 510 comprises a body portion 515 and a base portion 520. The body portion 515 includes an outer flange 545 having a straight inner wall 575 and an inner flange 560 having a curved outer wall 555. The body portion 515 also includes a spring locating guide 535. Optionally the body portion may also include a central socket 525 for attachment to a load. The base 520 portion of the perch assembly includes an annular wall 570 and a lateral flange 530. The annular wall portion 570 of the base has a curved outer wall 550 and a straight inner wall 565. The body portion 515 of the assembly is sized to receive the base portion 520 such that outer surface 555 of the inner flange 570 of the body member has a slightly smaller diameter than the inner surface 565 of the annular wall 570 of the base member and such that the outer surface 550 of the annular wall 570 of the base member has a slightly smaller diameter than the inner wall 575 of the outer flange 545 of the body member. This allows the body member to freely pivot relative to the base member without disengaging the base member. In one embodiment of the present invention, the body member may pivot up to approximately 4° relative to the base member. The present invention also contemplates assemblies which allow a greater or lesser range of pivot between the body member and the base member.

Preferably, the inner and outer wall of the body member and the inner and outer wall of the base member are machined to a smooth finish to reduce friction. Optionally, these surfaces may be coated with a low-friction material to further reduce friction. This material may be applied in any suitable manner such as spraying, spray and bake, or as a dry film. Examples of suitable materials include Krytox® and Teflon® manufactured by DuPont, although other suitable materials may also be used.

When the base member 520 is engaged with the body member 515, the inner surface 565 of the annular base wall 570 engages the outer surface 555 of the inner body flange 560 and the inner surface 575 of the outer body flange 545 engages the outer surface 550 of the annular base wall 570. This forms a circular cavity 590 between the body portion and the base portion of the assembly. To ensure the cavity is tightly sealed, O-rings 580 and 585 may be disposed between the inner surface of the annular base wall and the outer surface of the inner body flange and between the inner surface of the outer body flange and the outer surface of the annular base wall. Optionally, these O-rings 580 and 585 may be impregnated or coated with a low-friction material such as Krytox®. This cavity 590 may be filled with a volume of oil, hydraulic fluid or other suitable fluid, preferably until the body member floats on the fluid without disengaging from the base member.

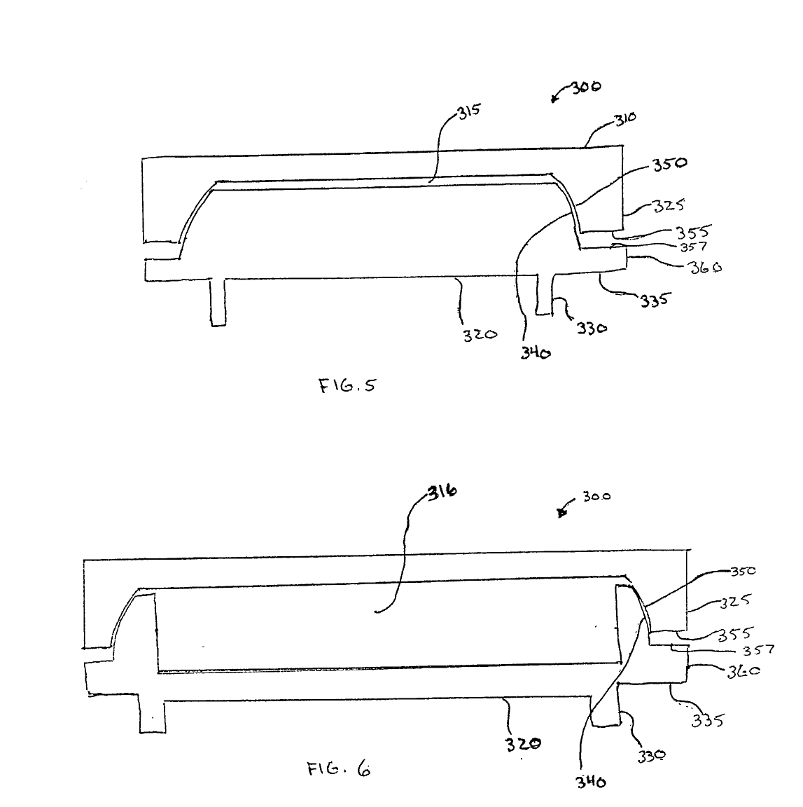

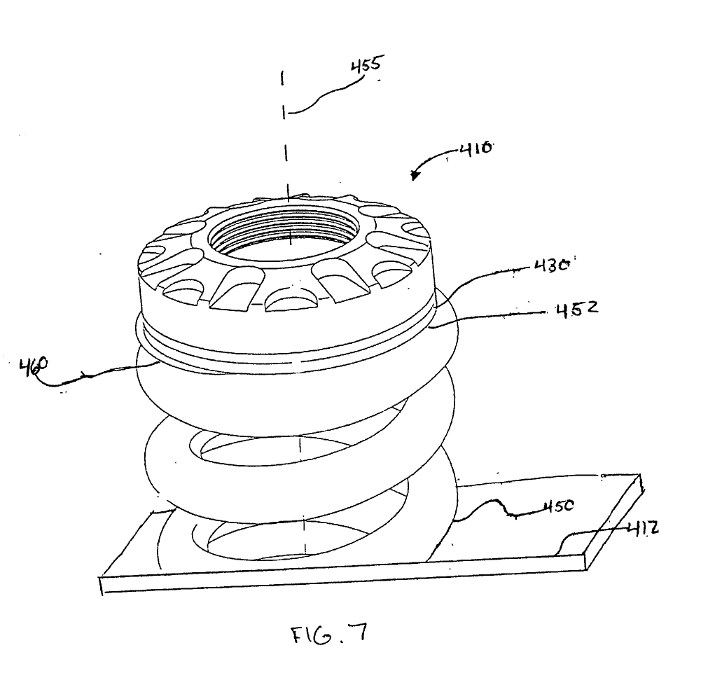

An alternate preferred spring perch assembly is shown in FIG. 5. A means for connecting objects to this particular embodiment and the embodiment illustrated in FIG. 6 such as the threaded socket 25 described in FIG. 3 has been omitted for clarity. It is understood that suitable means for attaching objects such as shock absorbers to this particular embodiment is used. In this embodiment of the present invention, the assembly 300 includes a body portion 310 and a base portion 320. The base portion includes a lateral flange 360, a spring locating guide 330 and a curved outer wall 340. The body portion includes a flange 325 having a curved inner surface 350. The curve of the inner surface 350 of the body flange complements the curve of the outer wall 340 of the base portion. Preferably, this curve is approximately spherical. The center of this curve is preferably located a distance above or below the face of the engaged spring. The components of the assembly are sized such that the outer wall 340 of the base portion has a slightly smaller diameter than the inner surface 350 of the body flange. This allows the body portion of the assembly to pivot relative to the base portion without disengaging the base portion. In one embodiment of the invention, the outer wall of the base portion has a diameter of 1.374 inches and the inner wall of the body portion has a diameter of 1.375 inches. In another embodiment, the body portion 310 of the assembly may pivot up to approximately 4° relative to the base portion 320. The present invention also contemplates assemblies which allow a greater or lesser range of pivot between the body member and the base member.

Optionally, the outer wall 340 of the base portion and the inner surface 350 of the body flange may be coated or impregnated with a low-friction material. In this embodiment, when the body portion and the base portion are engaged, the inner surface of the body portion directly engages the outer wall of the base portion. This forms a cavity 315 between the base portion and the body portion of the assembly. Preferably the outer wall 340 of the base portion and the inner wall 350 of the body portion are machined smooth to minimize friction between the two surfaces. Also, it is preferred that these surfaces be coated with a low-friction material to further minimize friction. This material may be applied in any desired fashion. Examples of suitable materials include Krytox® and Teflon® manufactured by DuPont, although other suitable materials may also be used. An alternate embodiment of this assembly having a larger cavity 316 is shown in FIG. 6.

FIG. 7 shows a spring perch assembly 410 according to one embodiment of the present invention engaged with a coil spring 450. The assembly is engaged with the spring 450 by inserting the spring locating guide (not shown) through the center of the spring coil until the upper surface of the coil 452 contacts the lateral flange 430 of the base portion of the assembly. The spring locating guide prevents lateral movement of the assembly relative to the spring. In this particular example, the end of the spring distal from the assembly is in contact with a fixed base 412. Although FIG. 7 shows a perch assembly engaged with the top of a spring, it is also contemplated by the present invention to use a single perch assembly engaged with the bottom of a spring. As seen in FIG. 8, a coil spring 450 may be engaged with one perch assembly 410, 411 at each end of the spring to further improve the load-centering performance of the present invention.

First, the operation of the embodiments of the present invention discussed previously in FIGS. 3-4 will be described with reference to FIG. 7. When a load is applied to the spring perch assembly body member, the load is initially concentrated at the point of first contact 460 between the spring and the perch assembly. The perch will tilt to accommodate the shape and twisting strength of the end coil. This load concentration depresses this area of the body portion of the assembly causing the hydraulic fluid in the cavity at that location to be compressed. This compression of the fluid forces a redistribution of the fluid throughout the cavity. Preferably, the cavity has sufficient clearance such that complete compression of the fluid is achieved before the load begins to be supported around the entire body portion of the assembly. Compression of the fluid continues until equal hydrostatic pressure is achieved throughout the fluid. Although tilting assists in redistribution, it will not redistribute the load with complete efficiency. Hydrostatic equilibrium within the fluid cavity completes the redistribution of the load evenly across the entire body portion of the assembly thereby maintaining the center of the applied load along the natural centerline 455 of the spring, thereby minimizing and/or eliminating any lateral components of the load. Although ideally minimized, residual friction between the body portion and the base portion prevents completely efficient redistribution.

Next, the operation of the embodiments of the present invention discussed previously in FIGS. 5-6 will be described with reference to FIG. 7. When a load is applied to the spring perch assembly body member, the load is initially concentrated at the point of first contact 160 between the spring and the perch assembly. This load concentration depresses this area of the body portion of the assembly initially causing an uneven loading of the spring. As an uneven load is applied, the centerline of the applied load deviates from the centerline of the spring, causing the body member of the assembly to pivot relative to the base member. This pivoting of the body member centers the load evenly across the body member, substantially returning the centerline of the applied load to the natural centerline of the spring. The minimization of friction enhances the equalization.

Additionally, the system can be made “self energizing” by changing the radius of curvature of the walls to move the center of rotation away from the spring face. While this introduces a slight buckling effect, it has been found that moving the center of rotation upward, away from the spring can increase the tilting effect and thus enhances the load equalization. This benefit is limited by the effect of the lateral movement of the spring end off of a centered position, which results in the final load being placed slightly off center.

As seen in FIG. 8, a spring 450 may be engaged with two assemblies 410, 411 according to the present invention. In this example, a first assembly 410 is engaged to a first end 452 of the spring 450 and a second assembly 411 is engaged to a second end 442 of the spring 450. The first assembly 410 is engaged with the spring 450 by inserting the spring locating guide (not shown) through the center of the spring coil until the upper surface of the coil 452 contacts the lateral flange 430 of the base portion of the assembly 410. The spring locating guide prevents lateral movement of the assembly relative to the spring. Similarly, the second assembly 411 is engaged with the spring 450 by inserting the spring locating guide through the center of the spring coil until the lower surface of the spring 453 contacts the lateral flange 431 of the base portion of the assembly 411.

A series of tests were performed to measure the reduction of lateral forces provided by spring perch assemblies according to several embodiments of the present invention. During the tests, various loads were applied to a test spring and the resulting lateral force measured. The test spring measured 4 inches long and 2.25 inches wide with a spring constant of 500 pounds per inch. Subsequently, spring perch assemblies according to the embodiment of the present invention depicted in FIG. 3 (Type 3) and in FIG. 4A (Type 4A) were employed in combination with the test spring during the testing procedure. The results of these tests are summarized in the following chart:

| | Lateral Force (lbs.) | | | |
|---|---|---|---|---|
| | Load | Load | Load | Load |
| | (lbs.) | (lbs.) | (lbs.) | (lbs.) |
| | 222 | 376 | 532 | 695 |
| Spring only | 116 | 233 | 402 | 571 |
| Type 3 on top | 59 | 91 | 166 | 313 |
| Type 3 on bottom | 61 | 98 | 151 | 240 |
| Type 3 on top and bottom | 7 | 10 | 21 | 50 |
| Type 4A on top | 68 | 174 | 337 | 514 |
| Type 4A on bottom | 62 | 148 | 306 | 466 |
| Type 4A on top and bottom | 40 | 140 | 303 | 482 |
| Type 4A on top, Type 3 on | 26 | 55 | 100 | 191 |
| bottom | | | | |
| Type 3 on top, Type 4A on | 43 | 70 | 156 | 295 |
| bottom | | | | |

As can been seen in the chart, the greatest reduction in lateral force over that experienced by the spring alone was achieved by employing perch assemblies of the type shown in FIG. 3 at the top and bottom of the spring. This resulted in a 98% reduction in lateral force in the spring at an applied load of 376 pounds and a 96% reduction at an applied load of 532 pounds. While employing two perch assemblies clearly leads to the greatest reduction in lateral force, significant reductions were also achieved using a single perch assembly. For example, the use of a single Type 3 assembly on top of the test spring resulted in a 61% reduction in lateral force with an applied load of 376 pounds while a single Type 4 assembly on top of the test spring produced a 25% reduction using the same applied load.

While the invention has been illustrated and described in detail in the drawings and foregoing description, the same is to be considered as illustrative and not restrictive in character, it being understood that only the preferred embodiment have been shown and described and that all changes and modifications that come within the spirit of the invention are desired to be protected. The articles “a”, “an”, “said” and “the” are not limited to a singular element, and include one or more such element.

What is claimed is:

1. A load-centering perch assembly for a coil spring comprising:
a base member having a spring engaging portion and at least one body member engaging portion;
a body member having a load engaging portion and at least one base member engaging portion;
whereby said body member and said base member define a cavity when said at least one base member engaging portion is pivotably engaged with said at least one body member engaging portion.

2. The assembly of claim 1 wherein said cavity is annular in shape.

3. The assembly of claim 1 wherein said cavity is circular in shape.

4. The assembly of claim 1 wherein said cavity is filled with a fluid.

5. The assembly of claim 4 wherein said fluid is a hydraulic fluid.

6. The assembly of claim 1 wherein said at least one body member engaging portion and said at least one base member engaging portion are curved.

7. The assembly of claim 6 wherein the curve of said at least one body member engaging portion compliments the curve of said at least one base member engaging portion.

8. The assembly of claim 1 wherein said at least one body member engaging portion and said at least one base member engaging portion are spherically curved.

9. The assembly of claim 1 wherein said at least one body member engaging portion and said at least one base member engaging portion are coated with a low-friction material.

10. The assembly of claim 1 wherein said cavity is sealed with at least one O-ring type seal.

11. The assembly of claim 1 wherein said at least one body member engaging portion is curved and said at least one base member engaging portion is straight.

12. The assembly of claim 11 wherein said curve is spherical.

13. The assembly of claim 1 wherein said at least one body member engaging portion is straight and said at least one base member engaging portion is curved.

14. The assembly of claim 13 wherein said curve is spherical.

15. The assembly of claim 1 wherein one body member engaging portion is straight and engaged with one base member engaging portion which is curved and a second body member engaging portion is curved and engaged with a second base member engaging portion which is straight.

16. The assembly of claim 15 wherein said one base member engaging portion which is curved and said second body member engaging portion which is curved are spherically curved.

17. In combination:
a coil spring having a first end and a second end; and
at least one load-centering perch assembly comprising a base member pivotably engaged with a body member and a cavity disposed between said base member and said body member.

18. The combination of claim 17 wherein said cavity is filled with a fluid.

19. The combination of claim 18 wherein said fluid is a hydraulic fluid.

20. The combination of claim 17 wherein said at least one perch is engaged with said first end of said spring.

21. The combination of claim 17 wherein said at least one perch is engaged with said second end of said spring.

22. The combination of claim 17 wherein one perch is engaged with said first end of said spring and a second perch is engaged with said second end of said spring.

23. A method of centering a load applied to a coil spring, comprising:
providing a spring;
providing a load;
providing a perch assembly having a base member pivotably engaged with a body member and a cavity disposed between said base member and said body member;
mounting said perch assembly to said spring;
applying said load to said perch assembly; and
pivoting said body member relative to said base member to center said load on said spring.

24. The method of claim 23 wherein said pivoting is mechanically performed.

25. The method of claim 23 wherein said pivoting is hydrostatically performed.
